(19) United States
(12) Patent Application Publication
(10) Pub. No.: US 2006/0093766 A1
(43) Pub. Date: May 4, 2006

(54) Multi-directional elastic-like material

(76) Inventors: Alan Savicki, Oswego, IL (US); Shaun Thomas Broering, Ft. Thomas, KY (US)

Correspondence Address: THE PROCTER & GAMBLE COMPANY;INTELLECTUAL PROPERTY DIVISION, WINTON HILL TECHNICAL CENTER - BOX 161, 6110 CENTER HILL AVENUE, CINCINNATI, OH, 45224, US

(21) Appl. No.: 10/980,657

(22) Filed: Nov. 3, 2004

(51) Int. Cl. B32B 27/32

(52) U.S. Cl. 428/35.2; 428/181; 428/174

(57) ABSTRACT

A sheet material including a strainable network formed in the surface of the sheet material. The strainable network includes first network areas and second network areas, the first network areas substantially surrounding the second network areas. The second network areas include geometrically deformable elements, and the first network areas define substantially unformed portions of the sheet material surrounding the second network areas. The deformable elements are geometrically deformable in plural directions generally parallel to the plane of the sheet material to provide the sheet material with a stretchable elastic-like characteristic in response to elongation forces applied to the sheet material in plural directions.

### FIELD OF THE INVENTION

The present invention relates to web materials, and more particularly, to such web materials wherein the inherent elongation properties of a given web material may be modified. Specifically, the present invention relates to web materials in which the resistive force exerted by the web material to an applied elongation in a plurality of directions can be modified.

### BACKGROUND OF THE INVENTION

Web materials having modified properties to provide a desired resistive force to an applied elongation force on the web are generally known. Such web materials comprise flexible materials useful for forming flexible articles, e.g., flexible bags, which benefit from having a stretchable property facilitating elongation of the web material along a preferential axis of elongation.

Examples of known web materials are disclosed in U.S. Pat. Nos. 5,518,801 (Chappell et al.), 5,650,214 (Anderson et al.), 6,394,651 (Jackson), 6,394,652 (Meyer et al.) and 5,151,092 (Buell et al.).

As utilized herein, the term “flexible” is utilized to refer to materials that are capable of being flexed or bent, especially repeatedly, such that they are pliant and yieldable in response to externally applied forces. Accordingly, “flexible” is substantially opposite in meaning to the terms inflexible, rigid, or unyielding. Materials and structures that are flexible, therefore, may be altered in shape and structure to accommodate external forces and to conform to the shape of objects brought into contact with them without losing their integrity.

In one prior art material, such as may be used in an absorbent article, traditional elastics have been secured to portions of the topsheet and/or backsheet of absorbent articles, such as the waist portion of a disposable diaper, to provide a better fit and overall comfort for the wearer. However, traditional elastics are costly and require a certain degree of manipulation and handling during assembly. While traditional elastics do provide a degree of stretch for the absorbent article, the materials to which the traditional elastic is secured are typically not normally considered elastic or stretchable. Therefore, the added traditional elastics must be prestretched prior to being secured to the material or the material must be subjected to mechanical processing, e.g., ring rolling, to permanently elongate the material to extend beyond its initial untensioned length and allow the added traditional elastic to be effective.

In accordance with further prior art materials, web materials are provided which exhibit an “elastic-like” behavior in the direction of applied elongation without the use of added traditional elastic. As used herein, the term “elastic-like” describes the behavior of web materials which when subjected to an applied elongation, the web materials extend in the direction of applied elongation and when the applied elongation is released the web materials return, to a substantial degree, to their untensioned condition. Such web materials exhibiting an elastic-like behavior have a wide range of utility, e.g. durable articles of apparel, disposable articles of apparel, disposable hygiene articles, covering materials such as upholstery, wrapping materials for complex shapes and the like.

In accordance with one construction providing an elastic-like material, a base material is formed with a strainable network comprising first areas defining a first network region and second areas defining a second network region, where the first and second regions may be expressed in terms of the length of the respective regions measured topographically over the surfaces of these regions when the strainable network is in an untensioned condition, i.e., expressed in terms of the “surface-pathlength” of the first and second network regions. The second network region has a “surface-pathlength” that is greater than that of the first network region. As used herein the term “surface-pathlength” refers to a measurement along the topographic surface of the region in question in a direction substantially parallel to an axis of the material. A method for determining the surface-pathlength of the respective regions can be found in the Test Methods section of the above-referenced U.S. Pat. No. 5,518,801 (Chappell et al.).

When an elongation force is applied to a strainable network, a rib-like element or rib-like elements, or a pleat or pleats, defining the second areas forming the second network region will undergo a geometric deformation under which they will flatten and extend while the first areas forming the first network region will undergo a molecular level deformation. This will cause the strainable network regions to exhibit an elastic-like behavior in the direction of the elongation force when subjected to an applied and subsequently released elongation force.

There continues to be a need for a flexible material comprising an elastic-like material for forming flexible articles where the properties of the elastic-like material enhance expansion of the material in response to forces applied across the material in a plurality of elongation directions.

### SUMMARY OF THE INVENTION

In accordance with one aspect of the invention, a sheet material is provided comprising first and second regions comprised of the same material composition. The second region initially undergoes substantially geometric deformation in plural directions when the sheet material is subjected to applied elongation forces in the plural directions.

In accordance with another aspect of the invention, a sheet material is provided exhibiting an elastic-like behavior in response to elongation forces applied in at least two transverse directions. The sheet material comprises a strainable network having first and second regions formed of substantially the same material composition, the first region providing a first resistive force to the applied elongation forces and the second region providing a second resistive force, less than the first resistive force, to the applied elongation forces, resulting in an initial geometric deformation of the second region. Subsequent to the geometric deformation of the second region, the first and second regions exhibit molecular level deformation in response to further application of the applied elongation forces.

In accordance with a further aspect of the invention, a sheet material is provided exhibiting an elastic-like behavior in response to an applied force in at least one direction. The sheet material comprises at least one region having a strainable network pattern. The at least one region undergoing substantially geometric elongation deformation in plural directions when the sheet material is subjected to the applied force.

### BRIEF DESCRIPTION OF THE DRAWINGS

While the specification concludes with claims particularly pointing out and distinctly claiming the present invention, it is believed that the present invention will be better understood from the following description in conjunction with the accompanying Drawing Figures, in which like reference numerals identify like elements, and wherein:

FIG. 1 is a plan view of a sheet material illustrating the present invention;

FIG. 2 is a segmented perspective view of a portion of the sheet material illustrated in FIG. 1;

FIG. 3 is a plan view of a sheet material formed with a first pleat pattern in accordance with the present invention;

FIG. 4 is plan view of a sheet material formed with a first pleat pattern, and with a second pleat pattern superimposed thereon in dotted lines;

FIG. 5 is a diagrammatic side elevational view of a set of meshing rolls for use in forming a strainable network on the sheet material;

FIG. 6 is a diagrammatic side elevational view of a set of meshing plates for use in forming a strainable network on the sheet material;

FIG. 7 is a diagrammatic side elevational view of two sets of meshing rolls arranged in series in a process direction for use in forming a strainable network on the sheet material;

FIG. 8 is a diagrammatic perspective view, including enlarged surface views, of a set of punch and die rolls for use in forming a multi-directional strainable network on the sheet material in a single pass;

FIG. 9 is a plan view of a sheet material illustrating a configuration for a strainable network formed by the punch and die rolls of FIG. 8;

FIG. 10 is a plan view of a sheet material illustrating another configuration for a strainable network in accordance with the present invention; and

FIG. 11 is a plan view of a flexible bag incorporating a multi-directional strainable network in accordance with the present invention.

### DETAILED DESCRIPTION OF THE INVENTION

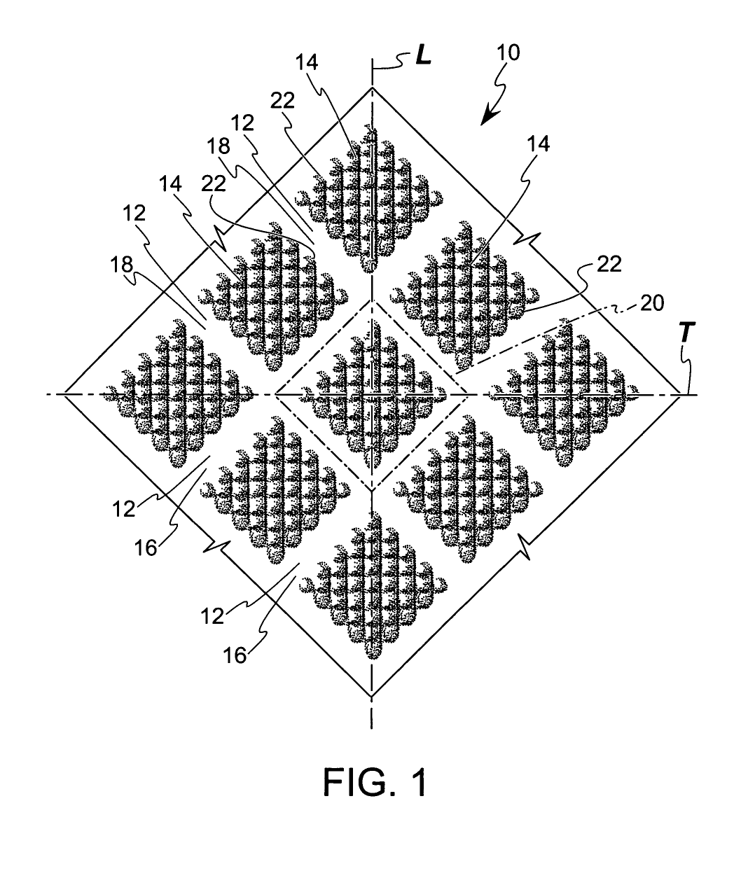

Referring to FIG. 1, a web or sheet material 10 illustrating the present invention is shown in which the sheet material 10 is formed with a “strainable network” of distinct regions. As used herein, the term “strainable network” refers to an interconnected and interrelated group of areas which are able to be extended to some useful degree in one direction, preferably a predetermined direction or a plurality of predetermined directions, providing the sheet material 10 with an elastic-like behavior in response to an applied and subsequently released elongation force. The strainable network includes a plurality of first areas 12 that define a first region and a plurality of second areas 14 that define a second region. Portions of the first areas 12, indicated generally as 16, extend in a first direction and are preferably substantially linear. Remaining portions of the first areas 12, indicated generally as 18, extend in a second direction that is substantially perpendicular to the first direction, and the remaining portions 18 of the first areas 12 are preferably substantially linear. While it is preferred that the first direction be perpendicular to the second direction, other angular relationships between the first direction and the second direction may be suitable. Preferably, the angles between the first and second directions ranges from about 45° to about 135°, with 90° being the most preferred. Intersecting sections of the portions 16 and 18 of the first areas 12 form boundaries 20 (only one shown in FIG. 1), indicated by a phantom line in FIG. 1, which completely surround the second areas 14. It should be understood that the boundaries 20 are not limited to the square shape illustrated herein and that boundaries 20 may comprise other shapes as required by the particular configuration of the first and second areas 12, 14.

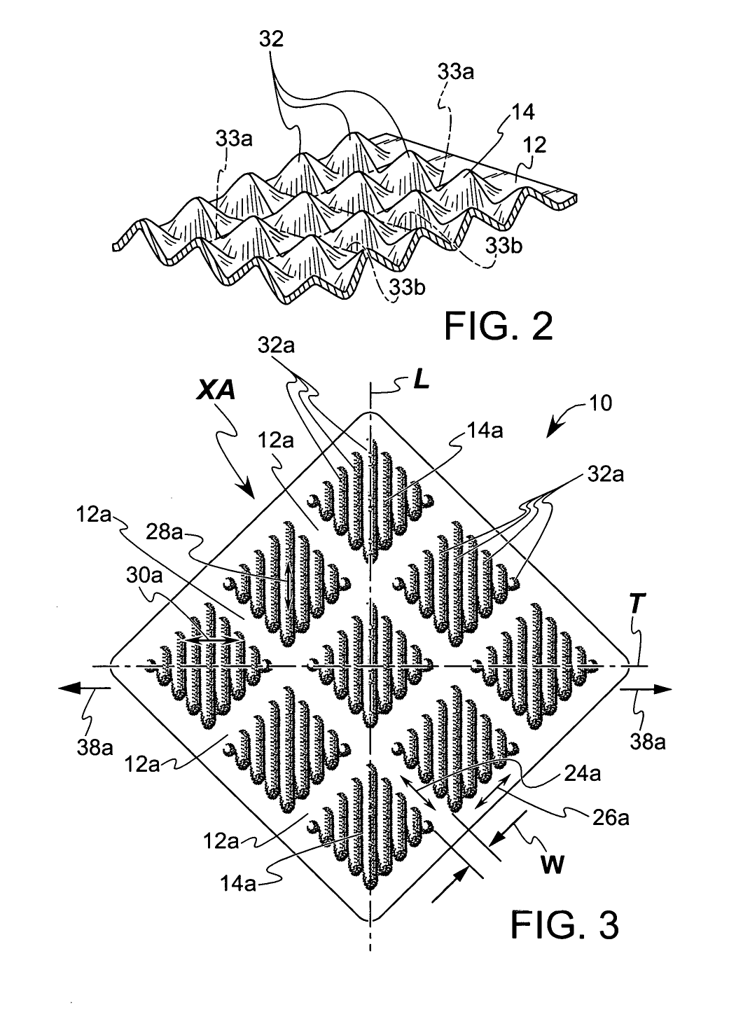

The sheet material 10 shown in FIG. 1 comprises a multi-directional strainable network providing stretch characteristics in multiple directions of elongation, as provided by at least two distinct and dissimilar regions comprised of the same material composition. A first region comprises first areas 12 generally illustrated as bands of unformed material generally lying in a plane defined by the sheet material 10. A second region comprises second areas 14 generally defined by nub-like elements or pleat portion patterns 32 (see FIG. 2) extending out of the plane of the sheet material 10 and comprised of a pleat portion or pleat portions extending in first and second distinct directions as formed by first and second superimposed pleat portion patterns, where the first and second pleat portion patterns are illustrated as being substantially similar to each other. However, those skilled in the art will appreciate that other pleat portion patterns are possible. It should be understood that the term “pleat portions” is intended to include continuous or discontinuous sections of pleats or pleat portions, such as may result, for example, from the intersection of first and second pleats or pleat portions with each other and which may result in pleat portion patterns 32 aligned in columns and rows aligned in the directions of the first and second pleats or pleat portions. As described further below, the first and second pleat portion patterns preferably are oriented substantially parallel to the longitudinal axis L and transverse axis T, respectively, of the sheet material 10. Further, it should be noted for the purposes of the description given herein that the terms “pleats” and “pleat portions” are not limited to plural pleats or pleat portions and may include one or more pleats or pleat portions. Also, the use of the term “areas”, i.e., first and second areas 12, 14, is not intended to be limited to plural areas and may include one or more areas defining the respective first and second regions.

As used herein, the term “formed” refers to the creation of a desired structure or geometry upon a sheet material 10 that will substantially retain the desired structure or geometry when it is not subjected to any elongations or externally applied forces. The sheet material 10 of the present invention is formed such that the first areas 12 are visually distinct from the second areas 14. As used herein, the term “visually distinct” refers to features of the sheet material 10 which are readily discernible to the normal naked eye when the sheet material 10 or objects embodying the sheet material 10 are subjected to normal use.

The elongation characteristics for both pleat portion patterns forming the strainable network can be essentially the same, but extending in different directions corresponding to the orientation of the particular pleat portion pattern, as will be described with particular reference to a first pleat portion pattern XA formed on the sheet material 10, as illustrated in FIG. 3. The first pleat portion pattern XA for the strainable network includes a group of first and second areas comprising a plurality of first areas 12a and a plurality of second areas 14a. The first areas 12a have a length extending along a first axis 24a and a width W extending along a second axis 26a. Preferably, the width W of the first area 12a is from about 0.01 inches to about 0.5 inches, and more preferably from about 0.03 inches to about 0.25 inches.

The second areas 14a have a first axis 28a and a second axis 30a. The first axis 28a is substantially parallel to the longitudinal axis L of the sheet material 10, while the second axis 30a is substantially parallel to the transverse axis T of the sheet material 10. Preferably, a first dimension of second area 14a extending along the second axis 30a is from about 0.01 inches to about 2.0 inches, and more preferably from about 0.125 inches to about 1.0 inches.

The first areas 12a are relatively unformed. That is, the material within the first areas 12a is in substantially the same condition before and after the formation step undergone by the sheet material 10. The second areas 14a include a plurality of raised pleat portions 32a. The width of the pleat portions 32a is substantially parallel to the second axis 30a and the length of the pleat portions 32a is substantially parallel to the first axis 28a. The length dimension of the pleat portions 32a is at least equal to, and preferably longer than the width dimension of the pleat portions 32a.

The pleat portions 32a in the second area 14a may be separated from one another by unformed areas. However, preferably, the pleat portions 32a are adjacent one another and are separated by an unformed area of less than 0.10 inches as measured perpendicular to the length of the pleat portions 32a and more preferably, the pleat portions 32a are contiguous having essentially no unformed areas between them.

The pleat portions 32a allow the second areas 14a to undergo a substantially, i.e., largely or essentially, “geometric deformation” which results in significantly less resistive forces to an applied elongation than that exhibited by the “molecular-level deformation” of the first areas 12a. As used herein, the term “molecular-level deformation” refers to deformation that occurs on a molecular level and is not discernible to the normal naked eye. That is, even though one may be able to discern the effect of molecular-level deformation, e.g., elongation of the sheet material, one is not able to discern the deformation which allows or causes it to happen. This is in contrast to the term “geometric deformation”. As used herein the term “geometric deformation” refers to deformations of the sheet material which are generally discernible to the normal naked eye when the sheet material or articles embodying the sheet material are subjected to an applied elongation. Types of geometric deformation include, but are not limited to bending, unfolding, and rotating.

The first areas 12a have a surface-pathlength which is less than the surface-pathlength of the second areas 14a (which includes the distances measured across the pleat portions 32a) as measured topographically in a direction parallel to the transverse axis T of the sheet material 10 while the sheet material 10 is in an untensioned condition. Preferably, the surface-pathlength of the second areas 14a is at least about 15% greater than that of the first areas 12a, more preferably at least about 30% greater than that of the first areas 12a and most preferably at least about 70% greater than that of the first areas 12a. In general, the greater the surface-pathlength of the second areas 14a, the greater will be the elongation of the sheet material 10 before encountering molecular level deformation. However, it should be noted that, within sheet 10, the first areas 12a will exhibit some molecular level deformation during the time that the areas 14a are exhibiting geometric deformation.

Sheet material 10 exhibits a modified “Poisson lateral contraction effect” substantially less than that of an otherwise identical base web of similar material composition. Further description and a method for determining the Poisson lateral contraction effect of a material can be found in the Test Methods section of above-referenced U.S. Pat. No. 5,518,801 (Chappell et al.) The Poisson lateral contraction effect of the sheet material 10 described for the present invention is determined by the amount of the sheet material 10 which is occupied by the first and second areas 12a, 14a, respectively. As the area of the sheet material 10 occupied by the first areas 12a increases, the Poisson lateral contraction effect also increases. Conversely, as the area of the sheet material 10 occupied by the second areas 14a increases, the Poisson lateral contraction effect decreases. The sheet material 10 provided by the present invention can be designed to moderate if not substantially eliminate the Poisson lateral contraction effect for materials that exhibit this effect.

When opposing planar forces are applied to the sheet material 10 of FIG. 3 in the direction of arrows 38a, an axial elongation of the sheet material 10 occurs in the direction of the transverse axis T. The elongation of the sheet material 10 is enabled by the unfolding or geometric deformation of the pleat portions 32a in response to the opposing planar forces. In addition to the above-described geometric deformation of the pleat portions 32a, it should be understood that a geometric contraction of the sheet material 10 can also occur in response to the applied elongation force in a direction orthogonal to the elongation direction.

The sheet material 10 includes transitional regions 22 which are at the interface between the first region defined by the first areas 12 and the second region defined by the second areas 14. The transitional regions 22 will exhibit complex combinations of the behavior of both the first areas 12 and the second areas 14. It is recognized that every embodiment of such sheet materials illustrating the present invention will have transitional regions 22; however, such materials are defined by the behavior of the sheet material 10 in the first areas 12 and the second areas 14. Therefore, the present description will be concerned with the behavior of the sheet material 10 in the first areas 12 and the second areas 14 only since it is not dependent upon the complex behavior of the sheet material 10 in the transitional regions 22.

As the sheet material 10 is elongated in response to opposing planar forces, the first areas 12a having the shorter surface-pathlength provide most of the initial resistive force as a result of molecular-level deformation. During the initial stage of elongation of the sheet material 10, the pleat portions 32a in the second areas 14a experience geometric deformation, or unfolding and offer minimal resistance to the opposing planar forces. In transition to the next stage of elongation, the pleat portions 32a become aligned with (i.e., substantially coplanar with) the plane of applied elongation. That is, the second areas 14a exhibit a change from geometric deformation to molecular-level deformation. This change in deformation mode is the onset of molecular deformation where the pleat portions 32a in the second areas 14a are substantially coplanar with the plane of applied elongation (i.e., the second areas 14a have reached their limit of geometric deformation) and begin to resist further elongation via molecular-level deformation. The second areas 14a subsequently contribute, as a result of molecular-level deformation, a second resistive force to further applied elongation. The resistive forces to elongation provided by both the molecular-level deformation of the first areas 12a and the molecular-level deformation of the second areas 14a provide a total resistive force which is greater than the resistive force which is provided by the molecular-level deformation of the first areas 12a and the geometric deformation of the second areas 14a.

The maximum elongation occurring prior to the pleat portions 32a becoming substantially aligned with the plane of applied elongation is the “available stretch” of the formed sheet material 10 in the direction of the applied forces indicated by the arrow 38. The available stretch corresponds to the distance over which the second areas 14a experience geometric deformation. The range of available stretch can be largely controlled by the extent to which the surface-pathlength in the second areas 14a exceeds the surface-pathlength in the first areas 12a and the composition of the base film. The term “available stretch” is not intended to imply a limit to the elongation to which the sheet material 10 of the present invention may be subjected as there are applications where elongation beyond the available stretch may be applicable. Additional description of the elastic-like elongation characteristics provided to a sheet material 10 formed with pleat portions or rib-like elements may be found in U.S. Pat. No. 5,518,801 (Chappell et al.).

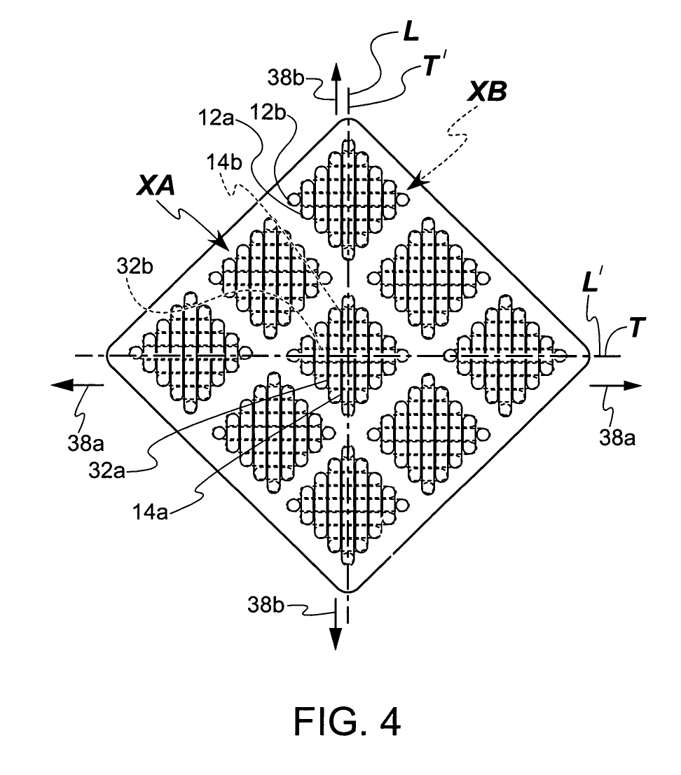

In one embodiment of the invention, subsequent to formation of the first and second areas 12a, 14a forming the first pleat portion pattern XA illustrated in FIG. 3, a second pleat portion pattern XB is formed on the sheet material 10 in substantially, i.e., largely or essentially, superimposed relation to the first pleat portion pattern XA. As seen in FIG. 4, the first pleat portion pattern XA is illustrated in solid lines prior to application of the second pleat portion pattern XB, and the second pleat portion pattern XB is illustrated in dotted lines superimposed on the first pleat portion pattern XA. The second pleat portion pattern XB is substantially, i.e., largely or essentially, identical to the above described first pleat portion pattern XA and comprises first areas 12b and second areas 14b, where the first areas 12b comprise substantially, i.e., largely or essentially, unformed bands of material and the second areas 14b are defined by a plurality of pleat portions 32b formed in the material 10. A longitudinal axis L′ and transverse axis T′ of the second pleat portion pattern XB are aligned in non-parallel or transverse relationship to the respective longitudinal axis L and transverse axis T described with reference to the first pleat portion pattern XA such that the pleat portions 32b of the second pleat portion pattern XB are oriented generally non-parallel or transverse to the pleat portions 32a of the first pleat portion pattern XA. In one preferred embodiment, the pleat portion pattern XB is oriented substantially perpendicular to the pleat portion pattern XA. However, it should be understood that the longitudinal and transverse axes L′, T′ of the second pleat portion pattern XB may by oriented at any angle defining a transverse relationship with the respective longitudinal and transverse axes L, T of the first pleat portion pattern XA, without being limited to the described perpendicular relationship.

The first areas 12b of the second pleat portion pattern XB are generally preferably contiguous with the first areas 12a of the first pleat portion pattern XA, and the second areas 14b of the second pleat portion pattern XB are generally contiguous with the second areas 14a of the first pleat portion pattern XA. As can be seen in FIG. 2, the strainable network includes trough portions, identified by phantom lines 33a, extending parallel to the pleat portions 32a of the first pleat portion pattern XA intersecting trough portions, identified by phantom lines 33b, extending parallel to the pleat portions 32b of the second pleat portion pattern XB. Accordingly, the second areas 14 of the strainable network are defined by formed material areas which comprise reticulated areas of pleat portions 32 which may be arranged, for example, in rows and columns defined between trough portions 33a and 33b, and the first areas 12 of the strainable network are defined by generally planar bands of substantially unformed material. The second pleat portion pattern XB superimposed on the first pleat portion pattern XA can provide the sheet material 10 with elongation characteristics substantially, i.e., largely or essentially, similar to the elongation characteristics described above for the first pleat portion pattern XA in response to application of elongation forces in the directions of arrows 38b, perpendicular to the elongation forces applied in the directions of the arrows 38a. The elongation characteristics of the sheet material 10 can be affected by the particular characteristics of the pleat portion patterns XA, XB and by the material characteristics of the sheet material 10. For example, in a sheet material 10 formed of a polymer material, the stretch or elongation characteristics may be altered or selected by providing selected pleat portion patterns XA, XB with differing pitches (pleat-to-pleat distance) and/or providing a particular alignment or orientation of the pleat portion patterns XA, XB relative to an aspect defining a stretch characteristic of the material, such as an orientation of the polymer structure forming the sheet material 10.

When the sheet material 10 is subjected to elongation due to applied forces, without intending to be bound to a particular theory of operation, it is believed that the sheet material 10 exhibits an elastic-like behavior as it extends in the direction of the applied forces and at least substantially returns to its untensioned condition once the applied forces are removed, unless the sheet material 10 is extended beyond the point of yielding. The sheet material 10 is able to undergo multiple cycles of elongation without losing its ability to substantially recover. Accordingly, the sheet material 10 is able to return to its substantially untensioned condition once the applied forces are removed. Further, the second areas 14 provide the sheet material 10 with a characteristic which exhibits an elastic-like behavior in multiple directions in response to elongation forces applied to the sheet material 10 in multiple directions.

Various materials known in the art are suitable for constructing the sheet material 10 described herein. For example, and without limiting the present invention, materials forming the sheet material 10 may comprise a polymeric material including polyvinyl chloride (PVC), polyvinylidene chloride (PVDC), and any polyolefin such as linear low density polyethylene (LLDPE), high density polyethylene (HDPE) or polypropylene and blends thereof. Examples of other polymeric materials include polyesters and polyurethanes. Other types of material may include aluminum foil, thin sheet metal, coated (waxed, etc.) and uncoated paper, coated nonwovens, and further including substantially permeable materials including any scrims, meshes, wovens, nonwovens, or perforated or porous films, whether predominantly two-dimensional in nature or formed into three-dimensional structures. In addition, the sheet material 10 may comprise a single composition or layer or may alternatively be a composite or laminate structure of disparate materials or multiple layers, or any combination thereof.

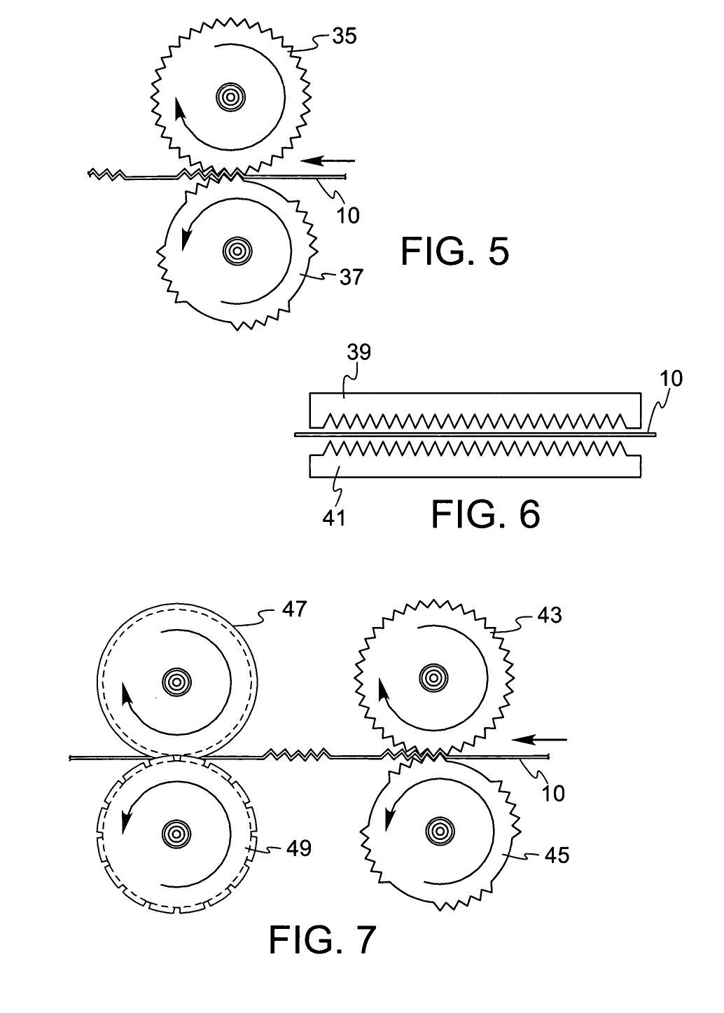

Methods for forming the sheet material 10 of the present invention include, but are not limited to, forming the sheet material 10 by mating plates or rolls, thermoforming, high pressure hydraulic forming, or casting. Examples of apparatus useful in forming the sheet material 10 may be found in U.S. Pat. No. 5,518,801 (Chappell et al.) and U.S. patent application Ser. No. 10/780,846, assigned to the assignee of the present invention, and in particular the referenced U.S. Patent and U.S. Patent Application disclose apparatus including meshing rolls and meshing plates for forming elastic-like material patterns in a single direction on a sheet of material. In a method of forming the strainable network having a multi-directional strainable network using forming members such as meshing rolls, for example using those illustrated in the above-referenced patent and patent application, a sheet of material may fed through meshing rolls 35, 37 (FIG. 5) or meshing plates 39, 41 (FIG. 6) in a transverse direction of the sheet material 10, corresponding to the transverse axis T direction of the pleat portions of the first pleat portion pattern XA. Subsequently, the sheet material 10 may be fed through the meshing rolls or meshing plates in a longitudinal direction of the sheet material 10, corresponding to the longitudinal axis L or the transverse direction T′ of the pleat portions of the second pleat portion pattern XB. In a preferred embodiment, the first and second areas 12b, 14b of the second pleat portion pattern XB are superimposed substantially, i.e., largely or essentially, in registration with respective first and second areas 12a, 14a of the first pleat portion pattern XA. However, it is contemplated that the registration of the second pleat portion pattern XB may be displaced relative to the first pleat portion pattern XA, such that at least a portion of the second pleat portion pattern XB is located in substantially, i.e., largely or essentially, non-overlapping relation to the first pleat portion pattern XA, and such that the first areas 12b of the second pleat portion pattern XB may cross over into the second areas 14a of the first pleat portion pattern XA, and the second areas 14b of the second pleat portion pattern XB also may cross over into the first areas 12a of the first pleat portion pattern XA. Such a displacement between the first and second pleat portion patterns XA, XB may provide beneficial elastic-like characteristics which vary from the characteristics provided by a strainable network formed of aligned corresponding first and second areas of the first and second pleat portion patterns XA, XB.

In a variation on the method of forming the first and second pleat portion patterns XA, XB by conveying the sheet material 10 through a single set of meshing rolls plural times with the sheet material 10 positioned in different orientations to provide different relative orientations between the pleat portions 32a, 32b of the second areas 14a, 14b, plural sets of meshing rolls may be provided in succession along a process line for the sheet material, each set of meshing rolls having an exterior configuration or pattern for forming pleat portions of a particular orientation on the sheet material. For example, as seen in FIG. 7, a first set of rolls 43, 45 may be provided with teeth for forming the pleat portions 32a of the first pleat portion pattern XA, and a subsequent second set of rolls comprising ring rolls 47, 49, where ring roll 49 is a patterned ring roll, may be provided for forming the pleat portions 32b of the second pleat portion pattern XB.

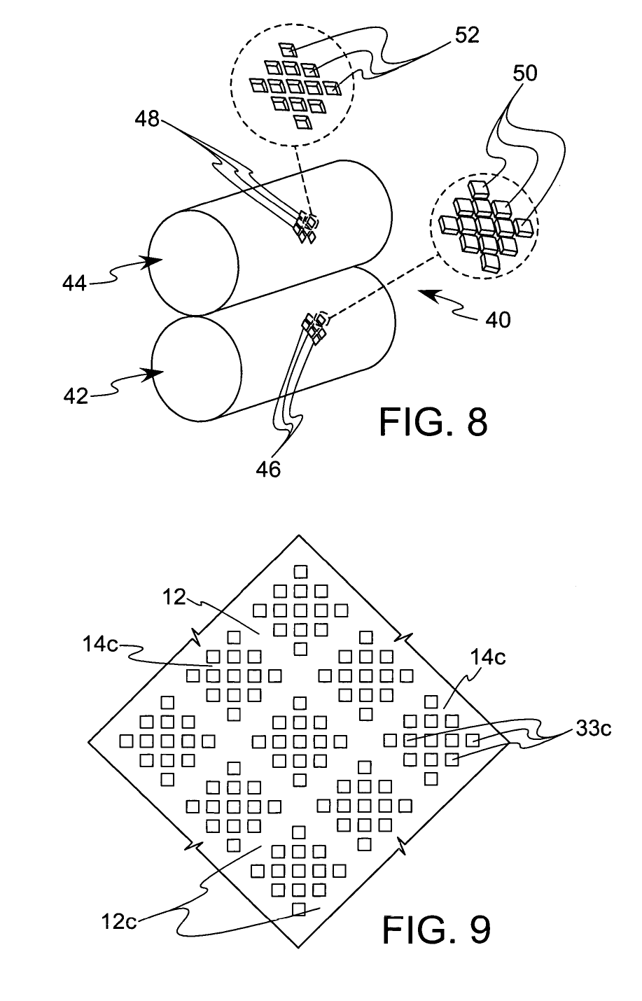

FIG. 8 illustrates a roll configuration for forming the multi-directional strainable network in a single pass through a set of meshing rolls 40. The meshing rolls 40 comprise punch roll 42 and a cooperating die roll 44, where the punch roll is provided with punch regions 46 and the die roll is provided with corresponding die regions 48 for cooperating with the punch regions 46. Further, the punch regions 46 are each provided with a plurality of punch elements 50 for cooperating with corresponding die elements 52 in the die regions 48, where cooperating engagement of the punch elements 50 with the die elements 52, with a sheet material therebetween, forms a pleat portion pattern on the material. Alternatively, the cooperating die roll 44 may comprise a conformable surface for conforming to the punch elements 50, or other surface configuration of the punch roll 42.

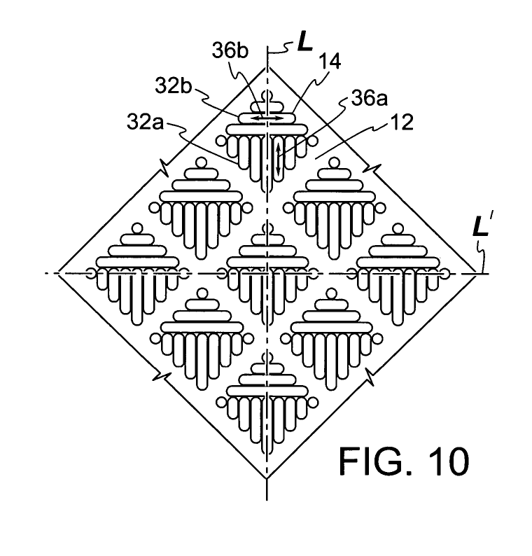

Referring to FIG. 9, a pleat portion pattern formed by the rolls 42, 44 is illustrated in which each of the second areas 14c of the multi-directional strainable network is formed by a cooperating set of punch and die elements 50, 52, such as is illustrated in the enlarged surface views of FIG. 8, and the remaining unformed areas define the first areas 12c of the multi-directional strainable network. The second areas 14c are defined by a plurality of deformed nub elements 33c. The nub elements 33c are aligned in columns and rows within each of the second areas 14c to define discontinuous pleat portions, where each discontinuous pleat portion comprises a series of nub elements 33c extending in either a longitudinal or a transverse direction. The second areas 14c define an area having a longer surface-pathlength than the first areas 12c and therefore provide areas that exhibit an initial geometric deformation in response to application of an elongation force in a manner similar to the previously described embodiments of the strainable network.

It should be understood that the present invention is not limited to the particular described pleat portion patterns, and that various pleat portion patterns may be applied to provide the sheet material 10 with a strainable network exhibiting elastic-like characteristics in multiple directions. An example of one variation of the pleat portion patterns is illustrated in FIG. 10 in which each of the second areas is divided into separate or distinct, substantially, i.e., largely or essentially, non-overlapping portions containing pleat portions 32a and 32b where the pleat portions 32a and 32b are aligned along different directions. In the illustrated example, the pleat portions 32a in one portion of the second areas 14 have a lengthwise axis 36a aligned parallel to the longitudinal axis L, defining a first pleat portion pattern, and the pleat portions 32b in the other portion of the second areas 14 have a lengthwise axis 36b aligned parallel to the longitudinal axis L′, defining a second pleat portion pattern.

In an alternative formation of the strainable network, the second pleat portion pattern may be formed by continuous ring rolls applied to a sheet material 10 having been formed with the first pleat portion pattern XA, such as the sheet material 10 having the first pleat portion pattern XA illustrated in FIG. 3. In the formation of this strainable network, the sheet material 10 of FIG. 3 is fed through the ring rolls such that the transverse axis T of the sheet material 10 extends parallel to the direction of travel through the ring rolls. The pleat portions formed by the ring rolls comprise a second pleat portion pattern which continuously extends parallel to the transverse axis T and passes through both the first and second areas 12, 14 of the first pleat portion pattern, positioning at least a portion of the second pleat portion pattern in non-overlapping relationship to the first pleat portion pattern.

The present invention is not limited to a particular described orientation of the pleat portions relative to the sheet material 10, nor is it limited to the particular angular orientation of the first pleat portion pattern XA relative to the second pleat portion pattern XB. The longitudinal axes of the pleat portions 32a, 32b of the first and second pleat portion patterns XA, XB may be oriented at any desired angle relative to the longitudinal axis L and transverse axis T of the sheet material 10, where the angle between the pleat portions 32a, 32b of the first and second pleat portion patterns XA, XB may be selected to provide for a preferential elongation characteristic in a particular direction, or directions, to accommodate a particular application or use of the sheet material 10.

It should also be understood that the pleat portion patterns defined in the second areas 14 of the strainable network may vary within the strainable network. For example, certain ones of the second areas 14 may be formed with pleat portions extending in a single direction corresponding to the orientation provided by the first pleat portion pattern XA, and other ones of the second areas may be provided with pleat portions extending in a single direction corresponding to the orientation provided by the second pleat portion pattern XB. In such a strainable network the differently oriented pleat portions may be separately located in different ones of the second areas 14.

Additionally, the second areas 14 may be provided with different shapes than the essentially square or diamond shape illustrated herein. For example, the second areas may comprise any shape including, without limitation, circular, elliptical, oval, or any number of multi-sided or polygonal shapes. Alternative shapes for the pleat portions 32 may also be provided. Additional variations of shapes and configurations for the pleat portions may be found in U.S. Pat. No. 5,518,801 (Chappell et al.).

The elongation characteristics associated with the pleat portions may be modified to increase or decrease the elastic-like behavior of the sheet material 10 by altering the height, size or shape of the pleat portions 32. Further, the elastic-like behavior of the sheet material 10 may be modified by forming additional pleat portion patterns, such as by forming three or more pleat portion patterns on the sheet material 10.

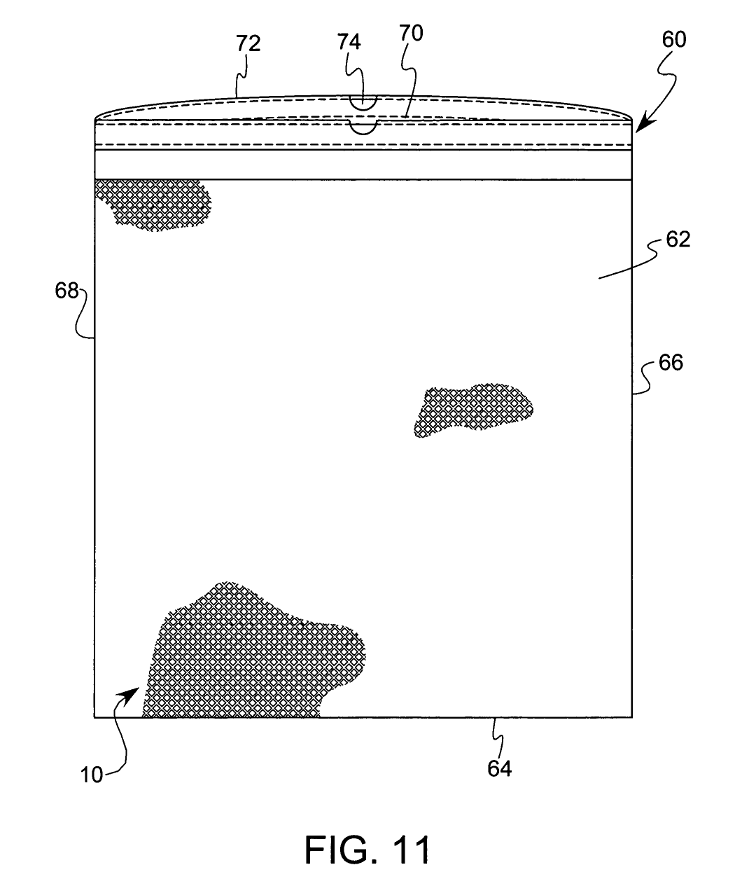

Referring to FIG. 11, in a particular application of the present invention, the sheet material 10 illustrated in FIG. 1 may be incorporated in a bag construction, such as a flexible bag 60. The flexible bag 60 includes a bag body 62 formed from a piece of the sheet material 10 folded upon itself along fold line 64 and bonded to itself along side seams 66 and 68 to form a semi-enclosed container having an opening 70 along an upper edge 72. The bag 60 also optionally includes closure means 74 located adjacent to the upper edge 72 for sealing edge 72 to form a fully-enclosed container or vessel. The closure means 74 can be supplied as flaps, adhesive tapes, a tuck and fold closure, an interlocking closure, a slider closure, a zipper closure or other closure structures known to those skilled in the art for closing a bag. The bag 60 is suitable for containing and protecting a wide variety of materials and/or objects contained within the bag body 62. In particular, the sheet material 10 of the present invention permits the bag 60 to readily expand in a plurality of directions in response to forces exerted by contents of the bag 60, providing an expansion of the volume of the bag 60 and/or in response to external forces acting thereon. In one embodiment of the bag 60, the entire surface of the sheet material 10 forming the bag 60 may include the strainable network. Alternatively, selected areas of the bag 60 may be preferentially provided with the strainable network, while other areas of the bag 60 may comprise unformed sheet material, such that the bag 60 includes preferentially expandable areas. For example, the strainable network may be provided to one or more of different regions vertically located along the bag (i.e., top region, middle region, lower region) to thereby provide a particular region, or regions, with a desired expansible characteristic.

In addition to providing the sheet material 10 of the bag 60 with an expansion characteristic, expanding the volume of the bag, the multidirectional strainable network of the present invention also improves the resistance of the sheet material 10 to puncture from the contents of bag 60 and/or from external objects. Further, the strainable network is resistant to propagation of tears through the sheet material 10 in that the bands defined by the first areas 12 operate as interference zones to resist further propagation of a tear.

It should be understood that the above description of a bag formed of the sheet material 10 of the present invention is only one example of an application of the sheet material 10. Other examples of articles which may implement an application of the sheet material 10 include, without limitation, diapers, sanitary napkins, bandages, wrapping materials, packing materials, food storage bags, food storage containers, thermal heat wraps, facial masks, wipes and hard surface cleaners.

All documents cited in the Detailed Description of the Invention are incorporated herein by reference; the citation of any document is not to be construed as an admission that it is prior art with respect to the present invention.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A sheet material comprising:
first and second regions being comprised of the same material composition;
said second region initially undergoing substantially geometric elongation deformation in plural directions when said sheet material is subjected to an applied force in at least one direction.

2. The sheet material of claim 1 wherein said second region includes deformable elements comprising plural pleat portions extending in plural directions within said second region.

3. The sheet material of claim 2 wherein said first region is substantially free of said plural pleat portions.

4. The sheet material of claim 2 wherein said plural pleat portions define first and second pleat portion patterns, said second pleat portion pattern being superimposed on said first pleat portion pattern.

5. The sheet material of claim 4 wherein said second pleat portion pattern is substantially the same as said first pleat portion pattern.

6. The sheet material of claim 4 wherein said second pleat portion pattern is oriented transverse to said first pleat portion pattern.

7. The sheet material of claim 2 wherein said plural pleat portions define first and second pleat portion patterns, where said second pleat portion pattern extends transverse to said first pleat portion pattern.

8. The sheet material of claim 7 wherein at least a portion of said second pleat portion pattern is located in substantially non-overlapping relationship to said first pleat portion pattern.

9. The sheet material of claim 1 wherein in response to said applied forces in at least one direction, said second region initially exhibits substantially geometric deformation and subsequently exhibits molecular level deformation.

10. A flexible bag including a bag body comprising the sheet material of claim 1.

11. A sheet material exhibiting an elastic-like behavior in response to an applied force in at least one direction, said sheet material comprising:
a strainable network having first and second regions formed of substantially the same material composition;
said first region providing a first resistive force to said applied force;
said second region providing a second resistive force, different from said first resistive force, to said applied force, resulting in an initial geometric elongation deformation of said second region in at least two transverse directions; and
subsequent to said geometric elongation deformation of said second region, said first and second regions exhibiting molecular level deformation in response to further application of said applied force.

12. The material of claim 11 wherein said second region is defined by at least first and second strainable network patterns, said second strainable network pattern being superimposed on said first strainable network pattern.

13. The material of claim 11 wherein said second region is defined by at least first and second strainable network patterns, and said strainable network patterns are defined by plural pleat portions extending across said material in multiple directions.

14. The material of claim 13 wherein said first region comprises substantially unformed material, and said second region is adjacent said first region and substantially comprises said strainable network patterns.

15. The material of claim 13 wherein said second strainable network pattern is superimposed on said first strainable network pattern.

16. A sheet material exhibiting an elastic-like behavior in response to an applied force in at least one direction, said sheet material comprising:
at least one region comprising a strainable network pattern;
said at least one region undergoing substantially geometric elongation deformation in plural directions when said sheet material is subjected to said applied force.

17. The sheet material of claim 16 wherein said at least one region comprises plural pleat portion patterns extending in plural directions.

18. The sheet material of claim 17 wherein said plural pleat portion patterns define nub-like elements forming a reticulated pattern.

19. The sheet material of claim 16 comprising at least first and second pleat portion patterns, where at least a portion of said second pleat portion pattern is located in substantially non-overlapping relationship to said first pleat portion pattern.

20. The sheet material of claim 16 comprising at least first and second pleat portion patterns, where said second pleat portion pattern is in substantially superimposed relationship to said first pleat portion pattern.
